(19) United States
(12) Patent Application Publication
(10) Pub. No.: US 2011/0300521 A1
(43) Pub. Date: Dec. 8, 2011

(54) PYTHAGOREAN DIDACTIC SET

(75) Inventor: Antonio Saucedo Gonzalez, Col. Jardines del Pedregal (MX)

(73) Assignees: ABASTECEDORA RIMOVA, S.A. DE C.V., Col. Jardines Del Pedregral (MX); Antonio Saucedo Gonzalez, Col. Jardines Del Predregral (MX)

(21) Appl. No.: 13/201,472

(22) PCT Filed: Nov. 6, 2009
(86) PCT No.: PCT/MX2009/000120

§ 371 Date: Aug. 15, 2011

(30) Foreign Application Priority Data
Mar. 3, 2009 (MX) MX/U/2009/000065

(51) Int. Cl. G09B 23/04

(52) U.S. Cl. 434/212

(57) ABSTRACT

The present invention refers to a new didactic Pythagorean set, being in the field of didactic material, which enables the students of college and university levels, to work in an implicit way the Pythagoras theorem; this is possible since this didactic material sets out in an arithmetic, geometric and algebraic way such famous result. Also, it enables the students of high school and college levels to be introduced to the trigonometric functions subject. Besides the present invention provides the user with a didactic tool whereby he could design and implement additional activities with the students, and incorporate such activities in any of the levels of study, as appropriate.

### FIELD OF THE INVENTION

The present Pythagorean didactic set, is in the field of didactic material allowing the students of college and university levels, to work in an implicit way the Pythagoras theorem; this is possible since this didactic material sets out in an arithmetic, geometric and algebraic way such famous result. Also, it allows the students of high school and college levels to be introduced to the trigonometric functions subject.

### OBJECTIVE OF THE INVENTION

The objectives of the present invention:

To use the incorporation of activities with the basic operations, allows that the student visualizes the operational proceedings under a different dynamic, also performing building activities of several types of figures.

To provide the user with a didactic tool whereby he could design and implement additional activities with the students, and incorporate such activities in any of the levels of study, as appropriate.

To stimulate the cognitive and playful areas of the students, under the principle of concrete-abstract and abstract-concrete. The above enables us to relate arithmetic, geometric and algebraic aspects, under learning dynamics, stimulating the training fields of space, shape and measure.

To stimulate the ability of using mathematics as an instrument to recognize, propose and solve problems.

To support in its formative role the development of operative and communicative skills of the students in order to acquire confidence and ability, while promoting the curiosity and creative imagination to adopt adequate strategies in the solving of various problems.

### BACKGROUND OF THE INVENTION

A fascinating subject and whose study starts from high school, is undoubtedly, the Pythagoras Theorem, the relevance of such result lies in its usefulness for students of college and university levels, due to the endless applications obtained from such result, for example: distance between two points, angles, trigonometric functions, etc. This is why nowadays there is an extensive amount of didactic products enabling the teaching of such important mathematic subjects in the academic training of the students. However, we can assure that the present invention introduces completely new elements such as the roulette and Pythagorean fan, which fulfill a structural conformation and a completely new design different from anything being part of the state of the art.

### BRIEF DESCRIPTION OF THE DRAWINGS

The new aspects featuring the present invention will be established in the claims accompanying the present application. However, the present set together with other objectives and advantages thereof, will be better understood in the detailed description and in the drawings described below:

FIGS. 1 to 4, show frontal, lateral and perspective views of the different geometric figures forming a square.

FIG. 5 shows perspective, lateral, rear and top views of the angle rule.

FIGS. 6 to 8, show perspective, lateral, frontal, top and bottom views of the square board for chips.

FIG. 9 show perspective, lateral and top views of the triangular board for chips.

FIG. 10 shows perspective, lateral, bottom and top views of the roulette.

FIG. 11 shows perspective, lateral, bottom and top views of the roulette adapter.

FIG. 12 shows perspective, lateral, bottom and top views of the dice.

FIG. 13 shows perspective, lateral, bottom and top views of the assembled Pythagorean fan.

FIG. 14 shows perspective, lateral, bottom and top views of the elements forming the Pythagorean fan.

FIG. 15 shows perspective, lateral, bottom and top views of the chip for the boards.

FIGS. 16 to 20 show perspective views of different forms, uses and applications of the Pythagorean board.

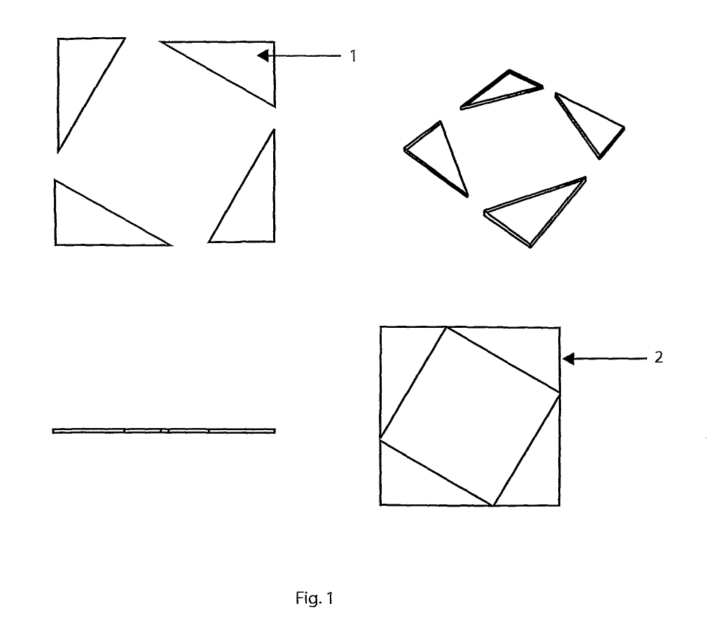

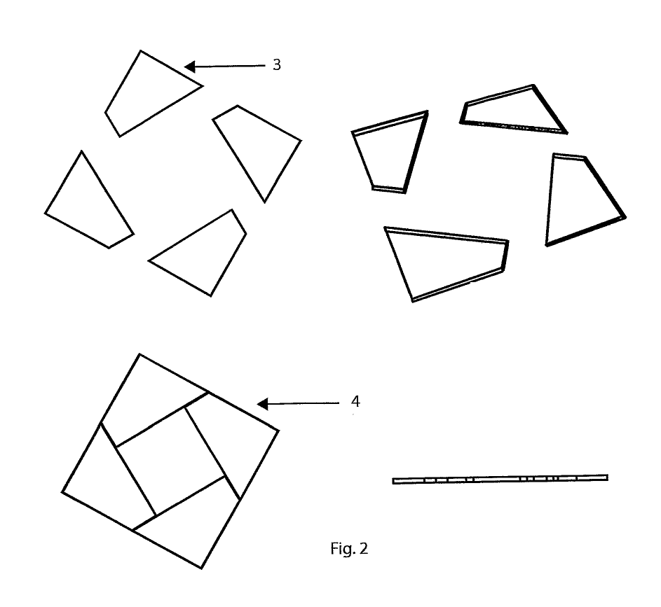

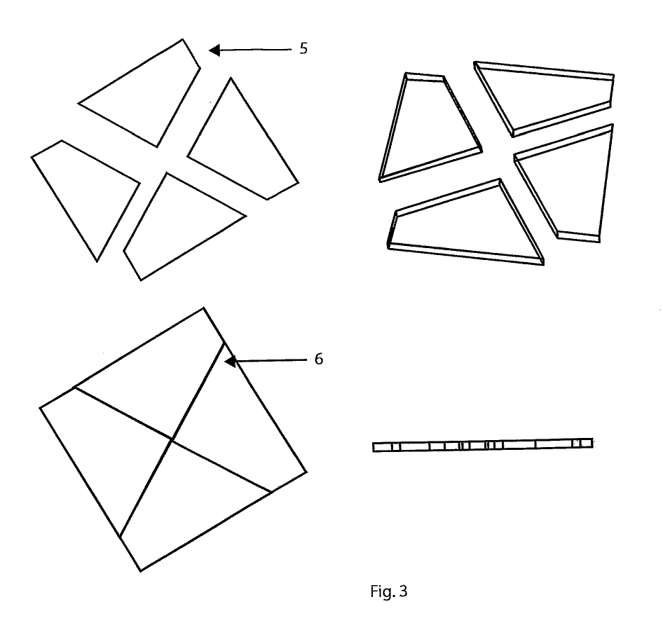

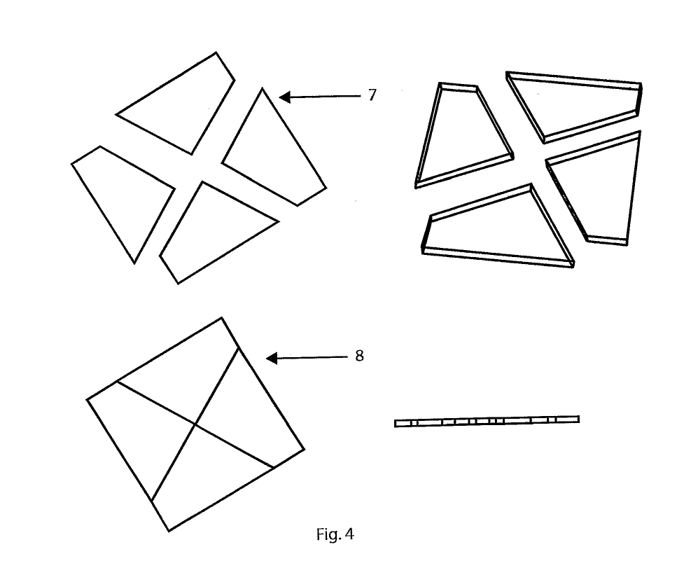

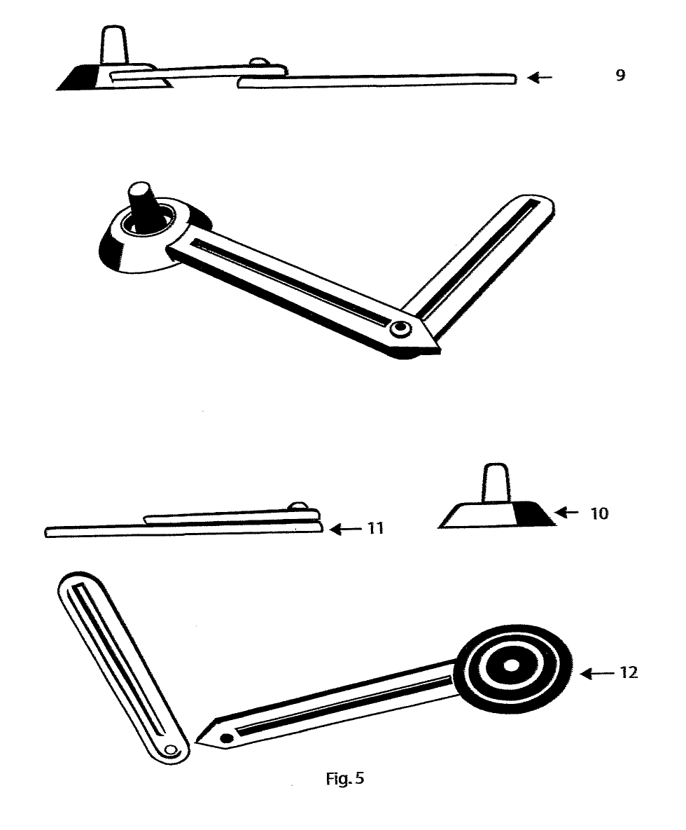

### DETAILED DESCRIPTION OF THE INVENTION

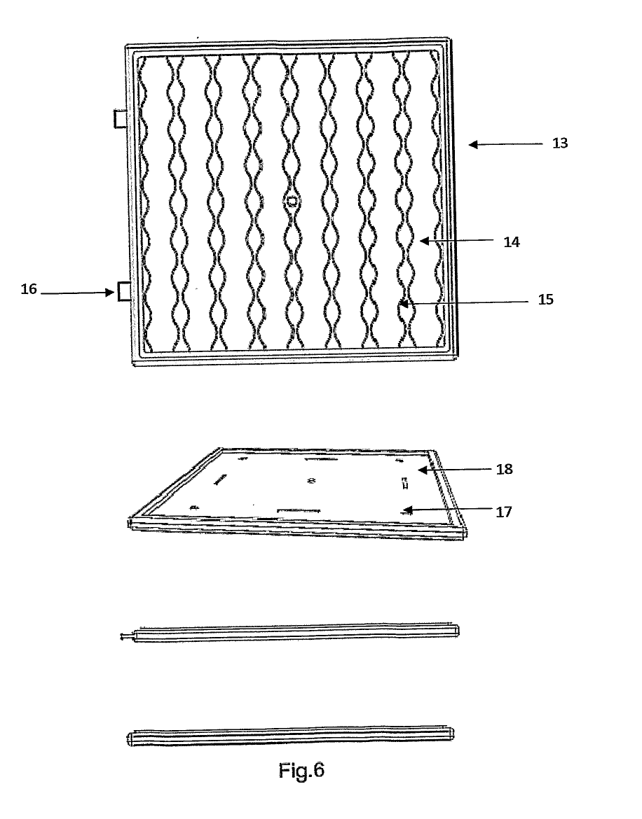

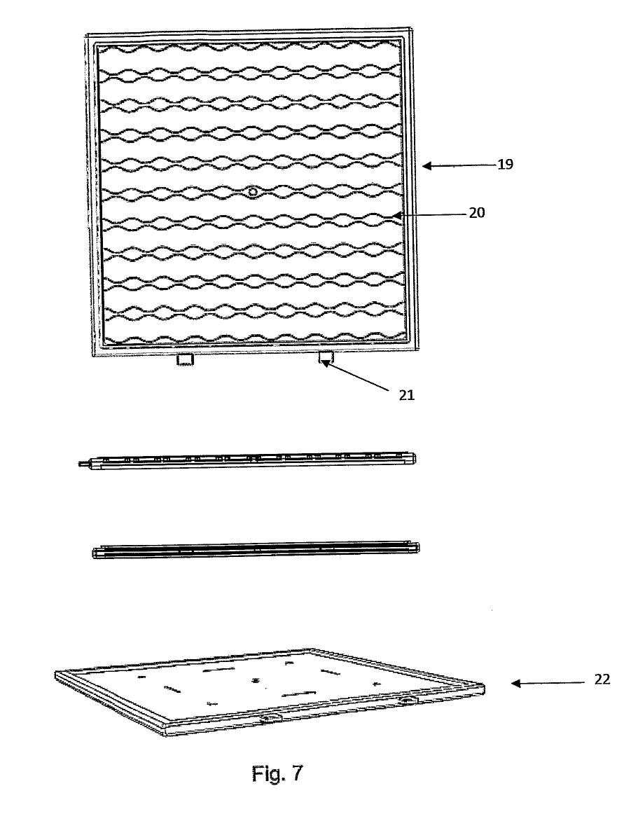

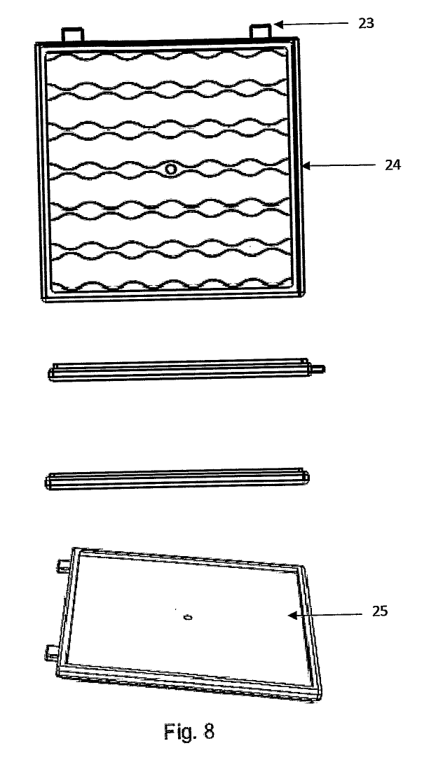

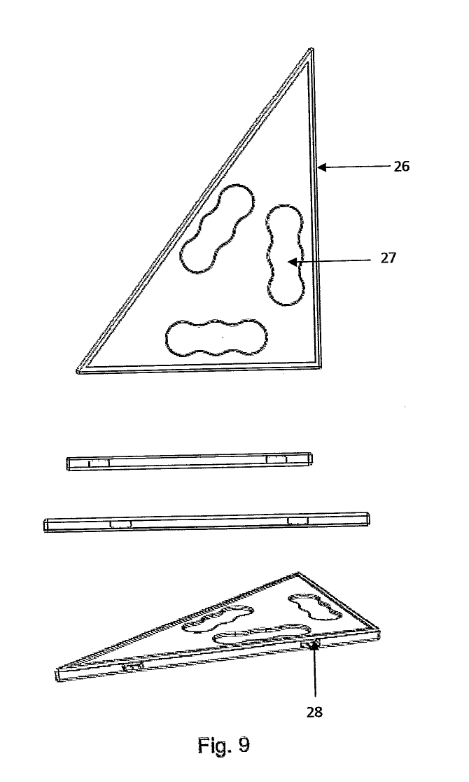

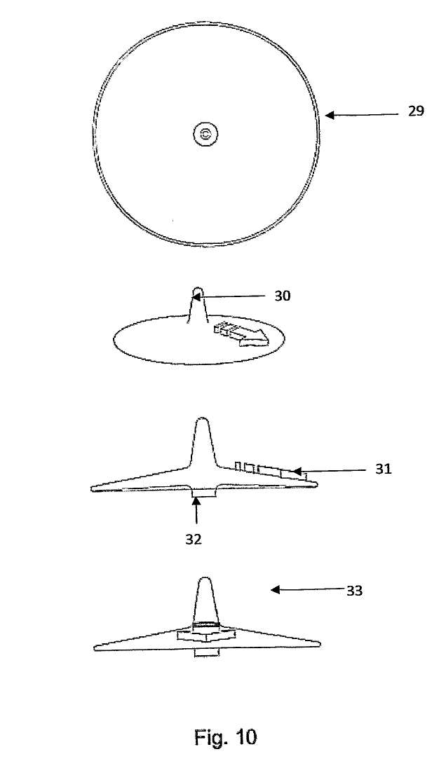

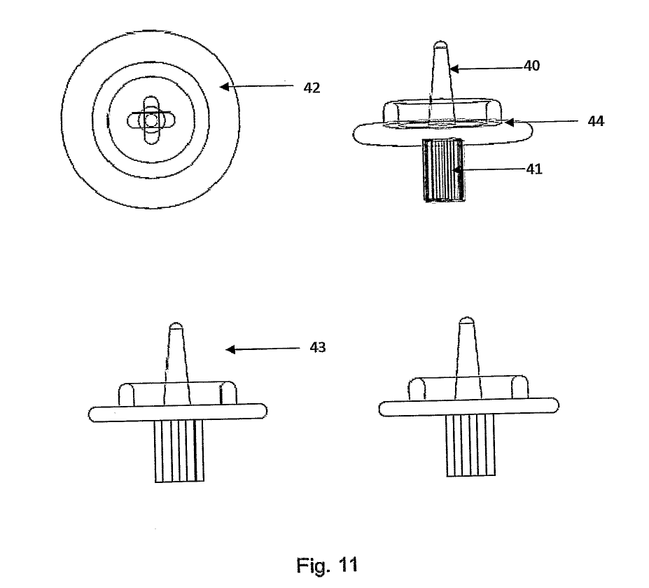

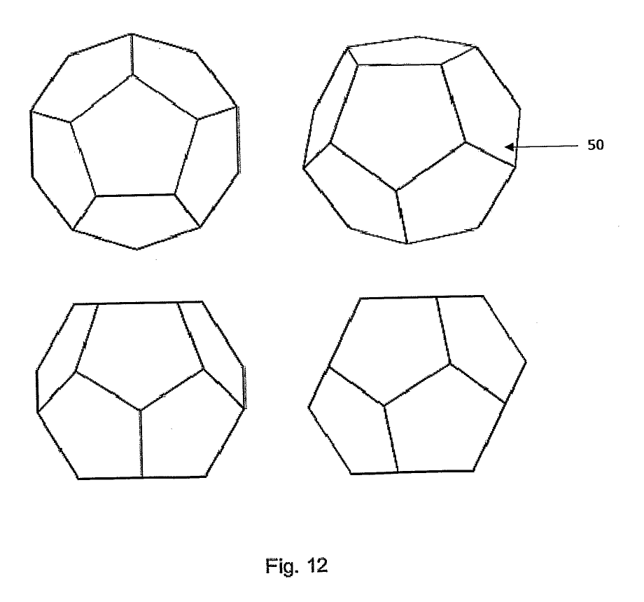

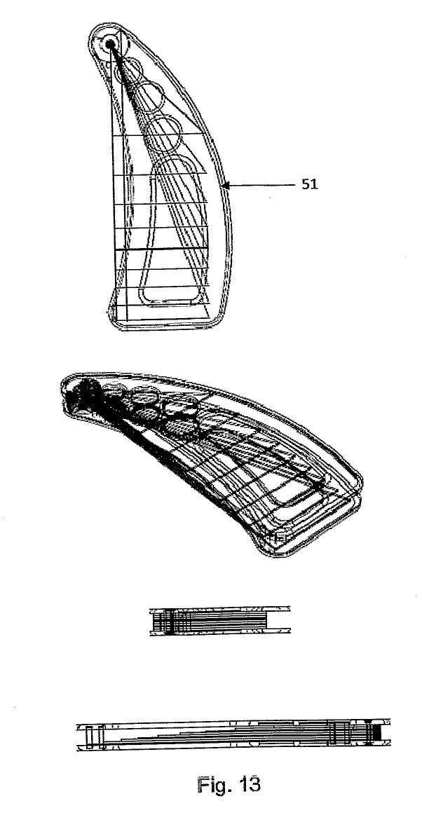

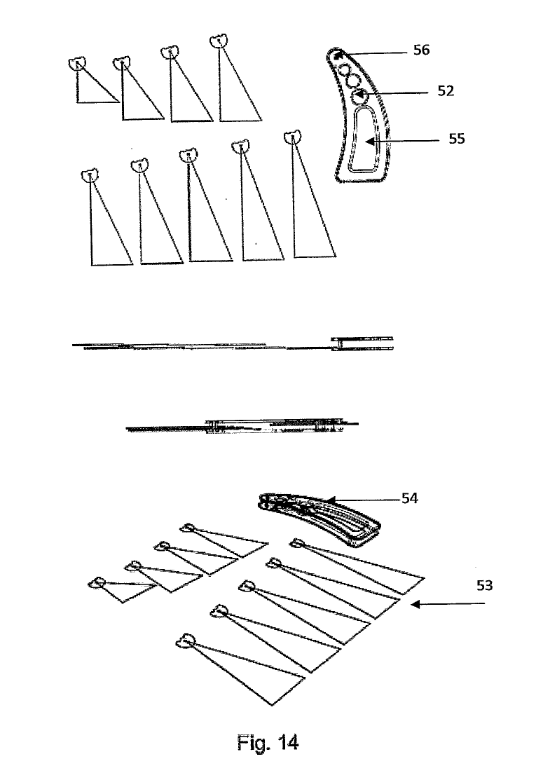

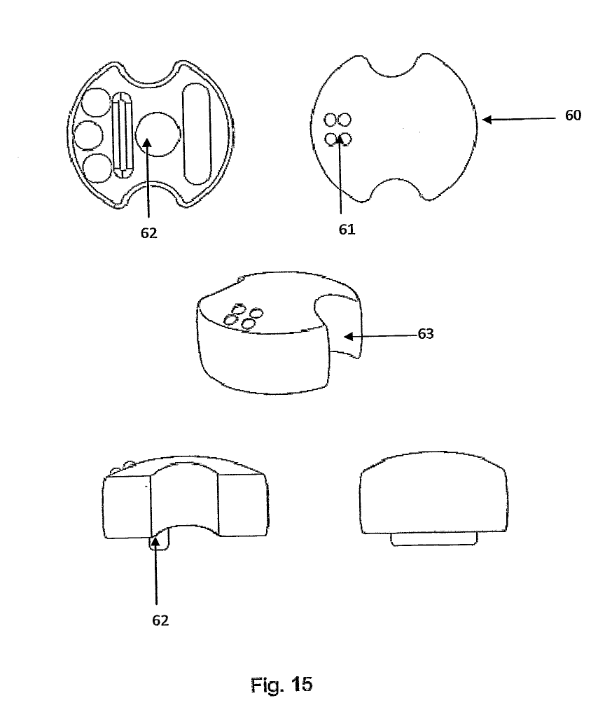

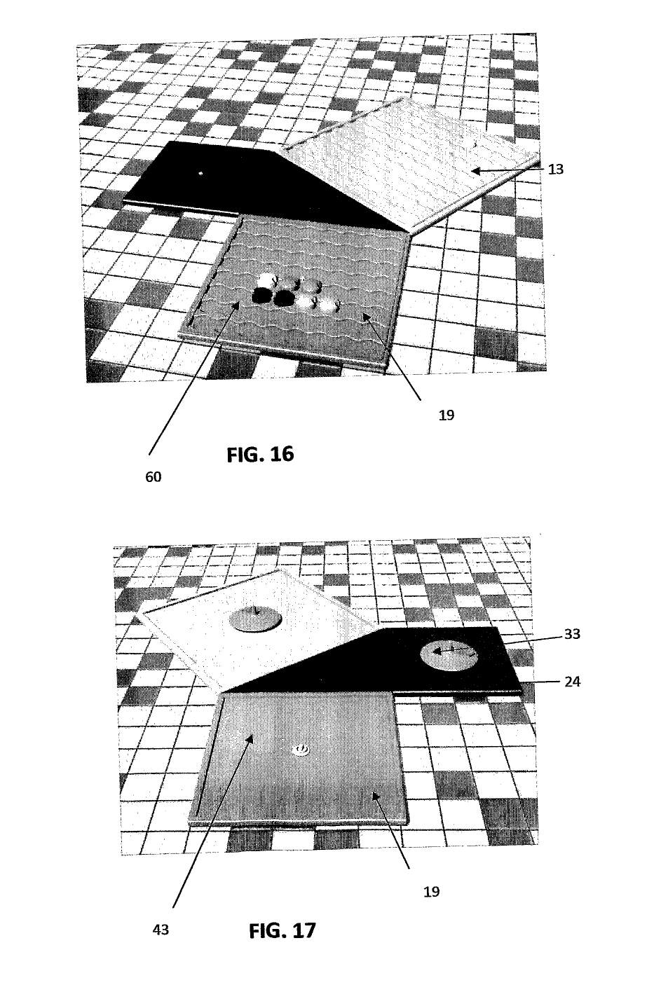

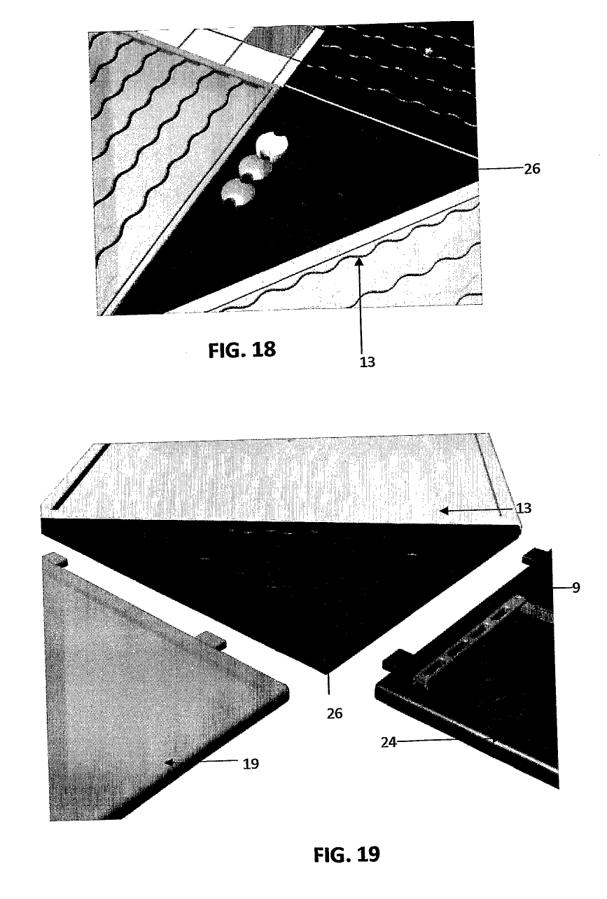

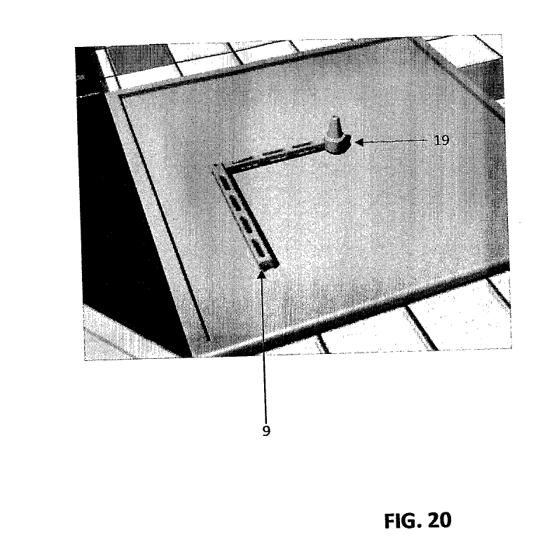

Referring particularly to FIGS. 6 to 9, it is shown a series of boards (1), from which three are generally square (13, 19, 24) and a fourth board (26) presenting a right-angled triangle, that is, one of its angles is of 90 degrees, so it defines a leg opposite to a leg adjacent and hypotenuse.

Said square boards (13, 19, 24) have de same composition of structure, however they correspond to the dimension of its sides to the total length of the legs and hypotenuse of the triangular board (26), that is, two square boards have the length of the corresponding legs and the third square has the length of the hypotenuse.

The triangular board (26) presents an upper surface and a lower surface, both surfaces are delimited by a perimeter frame in high embossment defining an inner zone in both surfaces. Both inner zones of the triangular board (26) have three lines in low embossment of undulated form (27), each one of them arranged parallel to one of the sides of the board. Each one of the sides of the board (26) has a pair of coupling slots (28).

Each square board (13, 19, 24) is formed as follows: a body presenting an upper surface and a lower surface (22), both surfaces being delimited by a perimeter frame in high embossment defining an inner zone in both surfaces. The inner zone of the upper surface, presents a plurality of parallel lines in high embossment (15, 20) in form of the symmetrical undulations, which are projected from one side to another of the board, defining free spaces (14) between each one of them, for the placement under pressure of the chips (60). The inner zone (18, 25) of the lower surface (22), presents edges in high embossment (17) allowing the coupling of the roulette (33) by an adapter for the roulette (40), as well as the coupling of an angle rule (9). One of the sides of the board (13, 19, 24) presents a pair of flanges of insertion (16, 21) arranged perpendicularly, whereby the square board (13, 19, 24) couples to the triangular board (26) in the respective coupling slots (28) thereof.

It should be noted that the square boards (13, 19, 24) and the triangular board (26), are made in different color each for a better understanding and differentiation of the application exercises.

The roulette (33) noted above, is composed of a disc that in its upper surface has centrally a sleeve (30) to manually rotate it and an arrow (31) in high embossment pointing out the disc. In its lower surface, the roulette (33) presents centrally a circular flange (32), whereby (33) it couples in the adapter for the roulette (40).

Said adapter for roulette and ruler (40) is formed by a first disc (44) having in its upper surface a second disc from which a support is vertically projected in which the circular flange (32) of the roulette (33) attaches, so that it can rotate by a manual impulse. The adapter has centrally in its lower surface (42) a circular base (41) whereby a pressure in any of the edges (17) of the lower surface of the boards (13, 19, 24) is fixed.

The chips (60) placed on the boards, are formed by a generally circular body presenting (63) two perimeter cuts (63) and opposite to each other, defining two recesses for being taken by hand. The lower surface of the chip (60) has a ledge (62) that at the time in which the chip is inserted in the board, it enables the chip (60) to keep a separation of the surface of the board, which in turn enables the manual release of the chip (60) of the board, since the chip has in its upper surface four points in high embossment (61) that when pressed, exercises a lever movement with the ledge (62) thus freeing the chip (60).

An angle ruler (9) formed by a first bar having vertically in one end a tapering body (10), which in turn has inferiorly an axial hole whereby it couples in the support of the adapter (40). A second bar (11) pivotally coupling in the opposite end to the end where the tapering body of the first bar is arranged.

Complementing the Pythagorean set there are:

A Pythagorean fan (51) composed of a pair of clear plates (54) of the same configuration, which have a tapering body slightly tilted presenting a series of longitudinal holes (52, 55) on its surface, both plates (54) are joined together parallel by bolts, so that there is a free space between them, in said inner space a plurality of triangular cards (23, 53) are placed pivotally joined by one of its ends to the narrowest end of the plates (54) by a bolt (56), so said cards may be taken out manually from the inner space of the plates (54).

A dice (50)

Different sets of triangles (1, 3, 5, 7) that by joining together, define squares (2, 4, 6, 8), of different sizes, for its application in the inner surfaces of the boards (13, 19, 24, 26).

According to the above described and illustrated in the drawings accompanying the present application, it can be appreciated that the present invention presents a unique structure formation and design. By the above, it will be evident to anyone skilled in the art that the embodiments previously described are only illustrative but no limitative of the invention, since there are numerous modifications that can be performed, as for example the referred to the materials, form, dimensions or size.

Even though specific embodiments of the invention have been described and illustrated, it is important to note that it is possible to perform numerous modifications thereof. Therefore, the present invention should not be considered as restrained except as required by prior art and by the claims accompanying this.

1. A didactic Pythagorean set comprising three generally boards (13, 19, 24) and a fourth board (26) of a right-angled triangle form, where each one of said four boards present an upper surface and an lower surface, wherein the surfaces of triangular board (26) are delimited by a perimeter frame in high embossment defining an inner zone of both surfaces, both inner zones have three lines in low embossment (27) of undulated form, each one of them is arranged parallel to one of the sides of the board, besides each one of the sides of the board (26) have a pair of coupling slots (28); both surfaces of each square board (13, 19, 24) are delimited by a perimeter frame in high embossment defining an inner zone in both surfaces, where the inner zone of the upper surface presents a plurality of parallel lines in high embossment (15, 20) in the form of symmetrical undulations, which projects from one side to another of the board defining free spaces (14) between each one of them for the placement under pressure of the chips (60), the inner zone (18, 25) of the lower surface (22), presents edges in high embossment (17) enabling the coupling of a roulette (33) by an adapter for the roulette (40), as well as the coupling of an angle ruler (9); one of the sides of each one of the boards (13, 19, 24) presents a pair of flanges of insertion (16, 21) perpendicularly arranged, whereby the square board (13, 19, 24) is coupled to the triangular board (26) in the respective coupling slots (28) thereof.

2. A didactic Pythagorean set according to claim 1, wherein said square boards (13, 19, 24) correspond in the dimension of its sides to the total length of the legs and hypotenuse of the triangular board (26), that is, two square boards have the length of the corresponding legs and the third square has the length of the hypotenuse.

3. A didactic Pythagorean set according to claim 1, wherein the square boards (13, 19, 24) and the triangular board (26), are made in different color each for a better understanding and differentiation of the application exercises.

4. A didactic Pythagorean set according to claim 1, wherein the roulette (33) is composed of a disc that in its upper surface has centrally a sleeve (30) to manually rotate it and an arrow (31) in high embossment pointing out the disc; in its lower surface, the roulette (33) presents centrally a circular flange (32), whereby (33) it couples in the adapter for the roulette (40).

5. A didactic Pythagorean set according to claim 1, wherein the adapter for roulette and ruler (40), is formed by a first disc (44) having in its upper surface a second disc from which a support is vertically projected in which the circular flange (32) of the roulette (33) attaches, so that it can rotate by a manual impulse; besides said adapter has centrally in its lower surface (42) a circular base (41) whereby a pressure in any of the edges (17) of the lower surface of the boards (13, 19, 24) is fixed.

6. A didactic Pythagorean set according to claim 1, wherein the chips (60) placed on the boards, are formed by a generally circular body presenting (63) two perimeter cuts (63) and opposite to each other, defining two recesses for being taken by hand; the lower surface of the chip (60) has a ledge (62) that at the time in which the chip is inserted in the board, it enables the chip (60) to keep a separation of the surface of the board, which in turn enables the manual release of the chip (60) of the board, since the chip has in its upper surface four points in high embossment (61) that when pressed exercises a lever movement with the ledge (62), thus freeing the chip (60).

7. A didactic Pythagorean set according to claim 1, wherein the angle ruler (9) is formed by a first bar having vertically in one end a tapering body (10), which in turn has inferiorly an axial hole whereby it couples in the support of the adapter (40). A second bar (11) pivotally coupling in the opposite end to the end where the tapering body of the first bar is arranged.

8. A didactic Pythagorean set according to claim 1, wherein the Pythagorean fan (51) composed of a pair of clear plates (54) of the same configuration, which have a tapering body slightly tilted presenting a series of longitudinal holes (52, 55) on its surface, both plates (54) are joined parallel together by bolts, so that there is a free space between them, in said inner space a plurality of triangular cards (23, 53) are placed pivotally joined by one of its ends to the narrowest end of the plates (54) by a bolt (56), so said cards may be taken out manually from the inner space of the plates (54).
